(19) United States
(12) Patent Application Publication
(10) Pub. No.: US 2012/0212604 A1
(43) Pub. Date: Aug. 23, 2012

(54) LIGHT BOX FOR VISUAL INSPECTION

(76) Inventors: Chin-Lai WU, Hsinchu (TW); Chun-Yen LIN, Hsinchu (TW)

(21) Appl. No.: 13/030,762

(22) Filed: Feb. 18, 2011

(51) Int. Cl. H04N 5/253; G09F 13/04

(52) U.S. Cl. 348/96; 362/97.1; 348/E05.049

(57) ABSTRACT

A light box for visual inspection includes a carrier plate, a light source, a shielding element and a controller. The carrier plate for carrying a sample is light-pervious. The light source is disposed on another side of the carrier plate for providing a light. The shielding element is disposed between the carrier plate and the light source for shielding a portion of the light which defines a light-pervious visual inspection region, wherein the size of the visual inspection region is equal to or less than the sample. The controller is electrically connected with the shielding element for driving the shielding element whereby the controller controls the size of the visual inspection region. The foregoing light box may shield the light of the region outside the sample, thereby preventing the strong light emitted from the light box from harming a user's eyes.

### BACKGROUND OF THE INVENTION

1. Field of the Invention

The present invention relates to a light box for visual inspection, and more particularly to a light box for visual inspection that may change the size of the light-pervious region.

2. Description of the Prior Art

In the past, when a negative film such as an X-ray film is inspected, it is placed on a light output side of a light box, and the light transmitted through the X-ray film allows a user to read the information on the X-ray film. The light output side of the prior art light box has a larger area than the X-ray film; therefore, area not covered by the X-ray film would emit strong light that could interfere with the user examining the X-ray film, and may also harm the eyes of the user. It is therefore highly desirable to find a solution to the above problem.

### SUMMARY OF THE INVENTION

The present invention is directed to a light box for visual inspection including a shielding element. The shielding element may adjust the light-pervious region of the light box in accordance with the size of a sample, so that the region outside the sample would not emit strong lights, and interference to the visual inspection of the sample and harmful effects to the user's eyes may be reduced.

According to an embodiment, a light box for visual inspection includes a carrier plate, a light source, a shielding element and a controller. The carrier plate is light-pervious and has a first surface and a second surface, wherein the second surface is for carrying a sample. A light source is disposed on the side of the first surface of the carrier plate for providing a light. The shielding element is disposed between the carrier plate and the light source for shielding part of the light which defines a visual inspection region pervious to light, wherein the size of the visual inspection region is equal to or less than the size of the sample. A controller is electrically connected with the shielding element for driving the shielding element whereby the controller controls the size of the visual inspection region.

The objective, technologies, features and advantages of the present invention will become more apparent from the following description in conjunction with the accompanying drawings, wherein certain embodiments of the present invention are set forth by way of illustration and examples.

### BRIEF DESCRIPTION OF THE DRAWINGS

FIG. 1 is a schematic diagram illustrating the light box for visual inspection according to an embodiment of the present invention;

FIG. 2 is a schematic diagram illustrating the corresponding relationship of the light-pervious region of the carrier plate, the visual inspection region of the shielding element and the sample according to an embodiment of the present invention; and

FIG. 3 is a schematic diagram illustrating the light box for visual inspection according to another embodiment of the present invention.

### DESCRIPTION OF THE PREFERRED EMBODIMENT

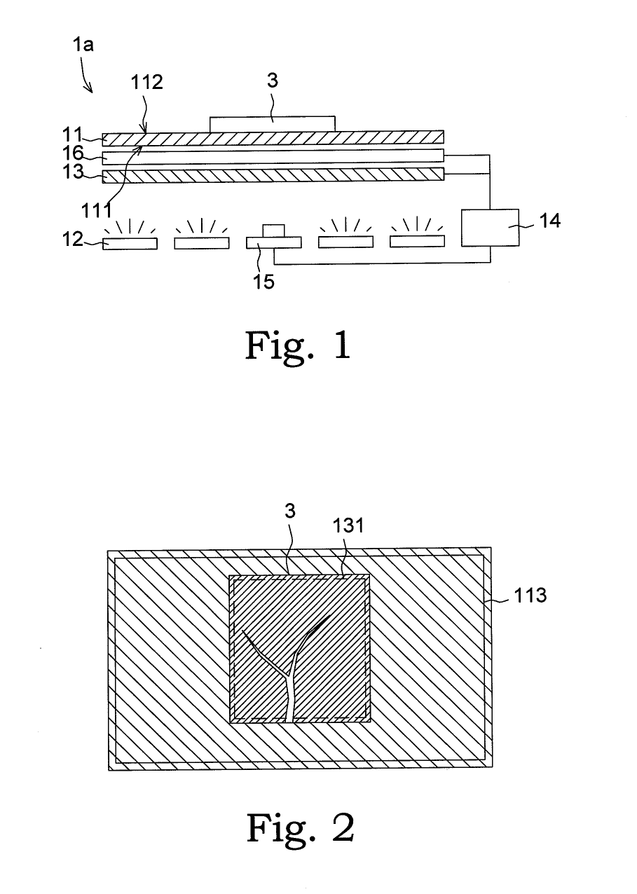

Referring to FIG. 1, a light box 1a for visual inspection according to an embodiment includes a base plate 11, a light source 12, a shielding element 13 and a controller 14. The carrier plate 11 is light-pervious and has a first surface 111 and a second surface 112. The sample 3 may be disposed on the second surface 112 of the carrier plate 111 for visual inspection. According to an embodiment, the sample may be a positive film, or a negative film such as an X-ray film. The light source 12 is disposed on the side of the first surface 111 of the carrier plate 11. The light source 12 is for providing a light to illuminate the sample 3. According to an embodiment, the light source 12 may comprise a light-emitting diode, cold cathode fluorescent lamp (CCFL), incandescent bulb, halogen lamp, gas-discharge lamp or the combination thereof.

The shielding element 13 is disposed between the carrier plate 11 and the light source 12. The shielding element 13 is for shielding part of the light emitted from the light source 12 which defines a light-pervious visual inspection region. The controller 14 is electrically connected with the shielding element 13. By driving the shielding element 13, the controller 14 can control the size of the visual inspection region. Referring to FIG. 2, when the sample 3 is being inspected, it is placed on the light-pervious region 113 of the carrier plate 11. Depending on the size of the sample 3, the controller 14 controls the size of the visual inspection region 131 of the shielding element 13 to be equal to or less than the size of the sample 3 so as to prevent the light from escaping through the light-pervious region 113 outside the sample 3. In this way, the user may use stronger lights to inspect more opaque samples, such as the X-ray film for industrial inspection use. According to an embodiment, the shielding element 13 may be a liquid crystal panel. Preferably, the carrier plate 11 is integrated with the shielding element 13.

Referring still to FIG. 1, the light box 1a for visual inspection according to an embodiment includes a detector 15 electrically connected with the controller 14. The detector 15 may detect the position and the size of the sample 3 and output a corresponding detection signal. Based on the detection signal, the controller 15 may then controls the size of the visual inspection region 131. For example, the detector 15 may be an image capturing element, such as a charged coupled device (CCD) or a complementary metal oxide semiconductor (CMOS) sensor. The controller 14 uses the image capturing element to capture the full image of the light-pervious region 113 of the carrier plate 11 and with the aid of the image processing technology, the controller 14 can determine the position and size of the sample 3. The controller 14 then drives the shielding element 13 to produce a corresponding visual inspection region 131 thereby preventing the light from escaping through the light-pervious region 113 outside the sample 3. According to an embodiment, the detector 15 may be an infrared sensor or an ultrasonic sensor. The controller 14 can determine the position and size of the sample 3 based on the infrared or ultrasonic signal blocked by the sample 3.

According to another embodiment, the light box 1a for visual inspection may include a user interface 16 electrically connected with the controller 14. The user interface 16 may allow a user to input a position signal corresponding to a position of the sample 3. For instance, the user interface 16 may be a touch panel, and by tapping at the diagonal positions of the rectangular sample 3, the position and the size of the sample 3 may be framed. According to the position signal output by the user interface 16, the controller 14 may then control the location and size of the visual inspection region produced by the shielding element 13.

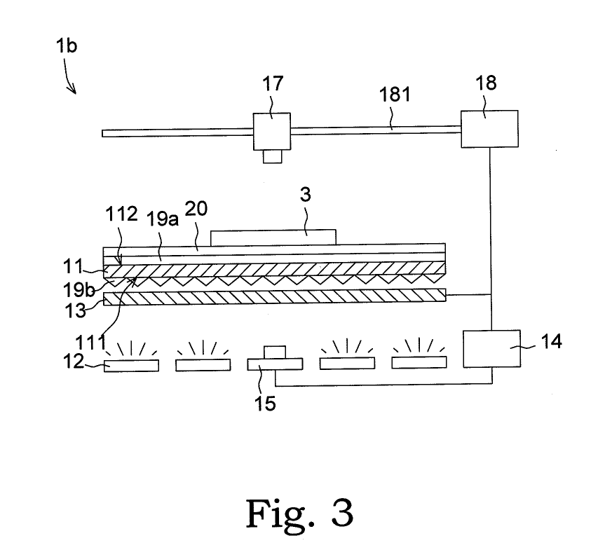

Referring to FIG. 3, the light box 1b for visual inspection according to an embodiment includes an image capturing device 17 disposed on the side of the second surface 112 of the carrier plate 11. The image capturing device 17 can capture the image of the sample 3 for the user to store the digital image of the sample 3. For example, the image capturing device 17 may be a charge coupled device (CCD) or a complementary metal oxide semiconductor sensor.

It is noted that the image capturing device 17 may be a linear image capturing device and the light box 1b for visual inspection according to the present embodiment includes a driving device 18 connected with the image capturing device 17. The driving device 18 may drive the image capturing device 17 to pass over the sample 3 by moving along the guiding element such as a slide rail 181 to scan the sample 3, thereby obtaining a full image of the sample 3. For instance, the driving device 18 may be a step motor. Note that when the scan of the sample 3 is not being performed, the image capturing device 17 may be moved to another position that does not affect the user inspecting the sample 3.

Referring still to FIG. 3, the light box 1b for visual inspection according to an embodiment may include a diffusion layer 19a, 19b disposed on at least one of the sides of the first surface 111 and the second surface 112 of the carrier plate 11. The diffusion layer 19a, 19b serves to make the light emitted by the light source 12 more uniform. For instance, the diffusion layer 19a may be a diffusion film attached to the light output side of the carrier plate 11 such as the first surface 111 or the second surface 112, or the upper surface of the shielding layer 13. Alternatively, the diffusion layer 19b may be a micro structure disposed on the first surface 111 of the carrier plate 11. It is noted that the diffusion layer may also be disposed between the light source and the shielding element. Preferably, a protection layer 20 can be disposed on the outermost side of the second surface 112 of the carrier plate 11. The protection layer 20 may prevent scratches to the light output side of the carrier plate 11 which can affect reading of the sample 3.

To summarize the foregoing description, the light box for visual inspection according to the present invention adds a shielding element and based on the position and the size of the sample, adjusts the light-pervious visual inspection region of the light box to prevent strong light emitted from the region outside the sample. Therefore, the light box of the present invention not only may reduce the interference during the visual inspection of the sample caused by the light escaping from the region outside the sample, but also may lower the harm to the user's eyes caused by the escaped strong light. Preferably, the light box of the present invention may automatically adjust the light-pervious visual inspection region according to the detected result of the detector.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. A light box for visual inspection, comprising:
a carrier plate which is light-pervious and has a first surface and a second surface, wherein the second surface is for carrying a sample;
a light source disposed on the side of the first surface of the carrier plate for providing a light;
a shielding element disposed between the carrier plate and the light source for shielding part of the light which defines a visual inspection region pervious to light, wherein the size of the visual inspection region is equal to or less than the size of the sample; and
a controller electrically connected with the shielding element for driving the shielding element whereby the controller controls the size of the visual inspection region.

2. The light box for visual inspection according to claim 1, wherein the shielding element comprises a liquid crystal panel.

3. The light box for visual inspection according to claim 1, wherein the carrier plate is integrated with the shielding element.

4. The light box for visual inspection according to claim 1, further comprising:
a detector electrically connected with the controller for detecting the position and size of the sample, and outputting a corresponding detection signal based on which the controller controls the size of the visual inspection region.

5. The light box for visual inspection according to claim 4, wherein the detector comprises an image capturing element, an infrared sensor or an ultrasonic sensor.

6. The light box for visual inspection according to claim 1, further comprising:
a user interface electrically connected with the controller for a user to input a position signal corresponding to the position of the sample, and based on the position signal, the controller controls the size of the visual inspection region.

7. The light box for visual inspection according to claim 6, wherein the user interface comprises a touch panel.

8. The light box for visual inspection according to claim 1, further comprising:
an image capturing device disposed on the side of the second surface of the carrier plate for capturing the image of the sample.

9. The light box for visual inspection according to claim 8, wherein the image capturing device comprises a charged coupled device or a complementary metal oxide semiconductor sensor.

10. The light box for visual inspection according to claim 8, further comprising:
a driving device connected with the image capturing device for driving the image capturing device to scan the sample.

11. The light box for visual inspection according to claim 1, further comprising:
a diffusion layer disposed on at least one of the sides of the first surface and the second surface of the carrier plate.

12. The light box for visual inspection according to claim 1, further comprising:
a diffusion layer disposed between the light source and the shielding element.

13. The light box for visual inspection according to claim 1, further comprising:
a protection layer disposed on the outermost side of the second surface of the carrier plate.

14. The light box for visual inspection according to claim 1, wherein the light source comprises a light-emitting diode, a cold cathode fluorescent lamp, an incandescent bulb, a halogen lamp, a gas-discharge lamp or the combination thereof.

15. The light box for visual inspection according to claim 1, wherein the sample comprises a positive film or a negative film.

16. The light box for visual inspection according to claim 1, wherein the sample comprises an X-ray film.
